(19) United States
(12) Patent Application Publication
(10) Pub. No.: US 2025/0192370 A1
(43) Pub. Date: Jun. 12, 2025

(54) Rolled But Partially Unsealed Separator Tube For An Electrochemical Cell

(71) Applicant: Greatbatch Ltd., Clarence, NY (US)

(72) Inventors: Eric M. Herberger, East Aurora, NY (US); Daniel M. Baumer, Middleport, NY (US)

(21) Appl. No.: 18/971,091

(22) Filed: Dec. 6, 2024

Related U.S. Application Data
(60) Provisional application No. 63/607,589, filed on Dec. 8, 2023.

(51) Int. Cl. H01M 50/469; H01M 4/38; H01M 4/583; H01M 10/052; H01M 50/107; H01M 50/152; H01M 50/179; H01M 50/191; H01M 50/46; H01M 50/545; H01M 50/559; H01M 50/627

(52) U.S. Cl. CPC H01M 50/469; H01M 4/382; H01M 4/5835; H01M 10/052; H01M 50/107; H01M 50/152; H01M 50/179; H01M 50/191; H01M 50/46; H01M 50/545; H01M 50/559; H01M 50/627

(57) ABSTRACT

An electrochemical cell has an electrode assembly comprising an anode active material contacted to the inner surface of a casing, and a cathode active material contacted to a current collector connected to the terminal pin of a GTMS supported by the casing. The cathode is wrapped in a separator having a first lateral edge and a spaced-apart second lateral edge. The separator first and second lateral edges extend from a lower edge to an opposite upper edge. With the separator wrapped around the cathode, a lower portion of the separator first and second lateral edges and the lower edge are sealed to cover a cathode lower end, and an upper portion of the separator first and second lateral edges and the upper edge are sealed to cover a cathode upper end, but the first and second lateral edges in an intermediate section are unsealed. An electrolyte activates the electrode assembly.

### CROSS-REFERENCE TO RELATED APPLICATION

This application claims priority to U.S. provisional application Ser. No. 63/607,589, filed on Dec. 8, 2023.

### BACKGROUND OF THE INVENTION

### 1. Field of the Invention

The present invention generally relates to the conversion of chemical energy to electrical energy. More particularly, the present invention relates to an electrochemical cell having an electrode assembly comprising lithium contacted to the inner surface of a cylindrically-shaped casing, preferably a tube-shape casing, and a cathode that is centered in the casing, spaced from the anode. The cathode is cylindrically-shaped and comprised of a cathode active material, preferably fluorinated carbon (CFₓ), that is contacted to a cathode current collector surrounded by but spaced from the lithium anode. A separator, for example, a polymeric separator is wrapped around the cathode to prevent the opposite polarity electrodes from physical contact with each other. Importantly, the separator is not sealed along a seam adjacent to a sidewall of the cathode where lateral edges of the separator are closely spaced to each other and preferably overlapped by a relatively short distance.

Instead, the separator is sealed only at the opposed ends of the cylindrically-shaped cathode. In one embodiment, the present electrochemical cell is a miniature-sized cell having a total size or volume that is less than about 0.5 cc.

### 2. Prior Art

Conventional cylindrically-shaped electrochemical cells, particularly Li/CFₓ cells, have cathode active material contacted to a metallic current collector which is connected to the terminal pin of a glass-to-metal seal (GTMS) comprising a lid closing an open end of a cylindrical or tube-shaped casing. A sheet of lithium as the anode active material is press-contacted to an inner surface of the casing so that the casing serves as the negative terminal for the cell. Then, a separator sheet, preferably of a polymeric material, is wrapped around the cathode to prevent the opposite polarity electrodes from physically contacting each other. Preferably, the separator sheet has a greater width than the circumference of the cylindrical cathode. This means that the opposed lateral edges of the separator overlap along a longitudinal seam extending along the cathode sidewall. The polymeric separator is then heat-sealed along this overlap to prevent the separator from unwrapping from around the cathode during cell assembly and discharge.

The problem is that the relatively long heat-sealed seam of overlapped separator material, which is typically comprised of melted and then solidified polymeric separator material, is a relatively dense and impermeable section down the side of the cathode that does not allow the transfer of lithium ions between the anode and the cathode. This results in a decrease in the discharge performance of the cell. For a relatively large cylindrically-shaped cell, the decrease in discharge performance is negligible. However, as cylindrical cells decrease in size, the size of the heat-sealed overlap stays relatively the same so that the effective area of the cathode that the heat-sealed overlap covers becomes a larger percentage of the overall cathode area, causing a more drastic reduction in cell performance.

Therefore, there is a need for an electrochemical cell, for example, a Li/CFₓ cell, having a cylindrically-shaped cathode that is centered inside a tube-shaped casing. A sheet of lithium is press-contacted to an inner surface of the casing. A polymeric separator sheet wrapped around the cylindrical cathode is heat-sealed at the opposed ends of the cathode, but the separator is not sealed down a longitudinal seam extending along the length of the cathode sidewall between the opposed ends. This helps to improve cell discharge performance because instead of a relatively dense and impermeable section of separator material, there is only unsealed separator around the entire circumference of the cathode directly facing the anode.

### SUMMARY OF THE INVENTION

Thus, the present invention addresses the need for a small separator profile that does not have a heat seal down the length of a cylindrically-shaped cathode. Traditional heat seal methods for securing a polymeric separator around a cathode leave a long heat seal down the side of the cathode facing the lithium anode. The melted and then solidified polymeric separator material becomes a relatively long ion impervious seam that does not allow the transfer of ions, thereby decreasing the discharge performance of the cell. As cylindrically-shaped cells decrease in size, the size of the heat-sealed seam stays relatively the same so that the effective area of the cathode that the sealed separator seam covers becomes a larger percentage of the overall cathode area, thereby causing a more drastic reduction in cell performance.

Accordingly, the purpose of the present invention is to form the separator, for example, a polymeric separator for an electrochemical cell in a way that does not create a heat-sealed seam down the side of the cylindrical cathode. This is accomplished by rolling a flat separator sheet around a mandrel to form a separator tube. After the mandrel is removed, the cylindrical cathode is inserted into the separator tube. Then, the upper edge and upper portions of opposed first and second lateral edges of the separator tube are sealed together to cover the cathode upper end, and the lower edge and lower portions of the first and second lateral edges of the separator tube are sealed together to cover the cathode lower end, but an intermediate section of the separator first and second lateral edges between the cathode upper and lower ends remains unsealed. Since the upper and lower ends of the cathode covered by sealed separator material do not face anode active material, there is not degradation in discharge performance attributed to them. However, the sealed separator material at the opposed cathode ends prevents the separator from unwrapping from around the cathode. Thus, the partially sealed separator tube of the present invention has the advantage of a full 360° profile of opposed cathode and anode active materials without an intermediate ion impervious separator seam, thereby improving cell performance, particularly in miniature-sized electrochemical cells.

These and other aspects of the present invention will become increasingly more apparent to those skilled in the art by reference to the following detailed description and to the appended drawings.

### BRIEF DESCRIPTION OF THE DRAWINGS

FIG. 1 is an elevational view, partly in cross-section, of an electrochemical cell 10 according to the present invention.

FIG. 1A is a cross-sectional view of the electrochemical cell 10 shown in FIG. 1.

FIG. 2 is a cross-sectional view taken along line 2-2 of FIG. 1.

FIG. 3 is a side elevational view of an exemplary cathode current collector 34 for the electrochemical cell 10 shown in FIGS. 1 and 2.

FIG. 4 is a side elevational view, partly broken away, of the proximal end 28A of a terminal pin connected to a land 36 of the cathode current collector 34 shown in FIG. 3 by a weld 46.

FIG. 5 is a side elevational view of a separator 16 according to the present invention.

FIG. 6 is a side elevational view of the separator 16 shown in FIG. 5 after having been rolled into a tube shape.

FIG. 7 is a perspective view of the rolled separator tube shown in FIG. 6.

FIG. 8 is a plan view of the rolled separator tube shown in FIGS. 6 and 7.

### DETAILED DESCRIPTION OF THE PREFERRED EMBODIMENTS

As used herein, the term “circumference” is defined as the external boundary or surface of an electrode, for example, a cathode in a case-negative cell design and an anode in a case-positive cell design.

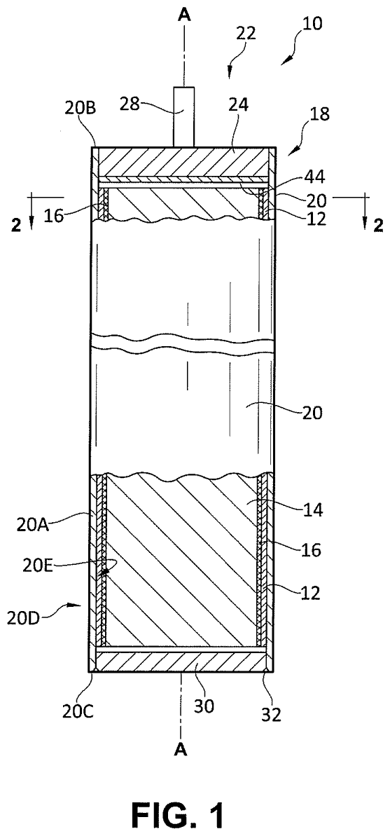

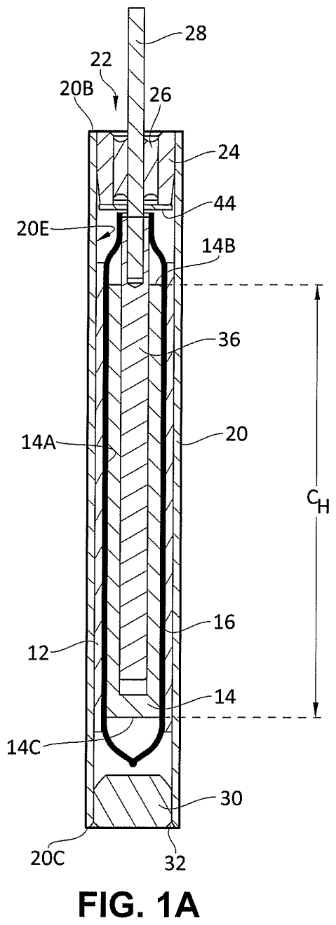

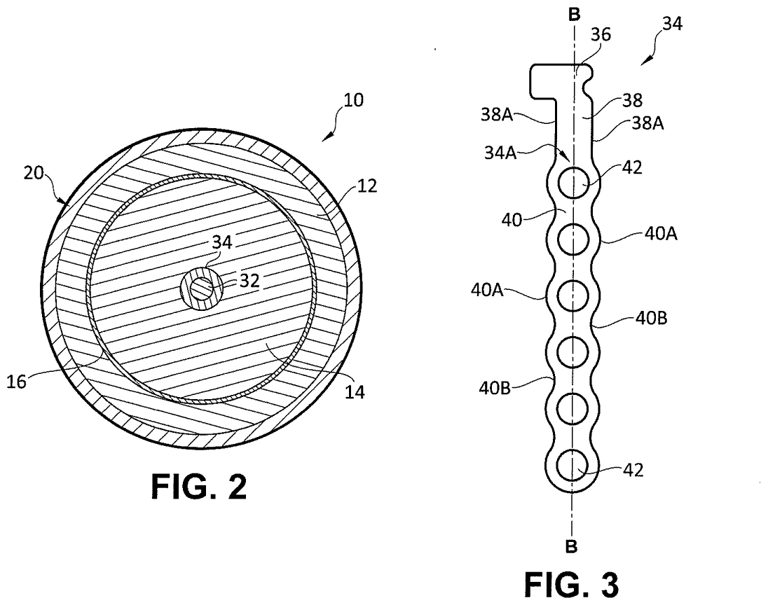

Turning now to the drawings, FIG. 1 is a partial cross-sectional view of an exemplary electrochemical cell 10 according to the present invention and FIG. 1A is a cross-sectional view of the cell 10 shown in FIG. 1. The cell 10 has an electrode assembly comprising an anode in the form of a layer of lithium 12 in electrical contact with the inner surface of a casing 18 and segregated from a cathode 14 by an ionically porous polymeric separator 16 (FIG. 2). Thus, the electrode assembly comprising the lithium anode 12, the cathode 14 and the intermediate separator 16 is housed inside a metallic casing 18 made from titanium, stainless steel, nickel, aluminum, or other suitable electrically conductive materials. The casing 18 comprises a cylindrically-shaped tube 20 having an annular sidewall 20A extending along a longitudinal axis A-A from a proximal open end defined by a proximal circular edge or annular rim 20B to a distal open end defined by a distal circular edge or annular rim 20C. The casing tube 20 also has an outer cylindrical surface 20D spaced from an inner cylindrical or annular surface 20E.

Further as shown in FIGS. 1 and 1A, a glass-to-metal seal (GTMS) 22 closes the proximal open end of the casing tube 20. The GTMS comprises a lid 24 supporting an insulator glass 26 that seals between an inner surface of the lid and a terminal pin 28. The lid 24 is welded to the proximal annular rim 20B to close the proximal open end of the casing tube 20. The insulator glass 26 is of a corrosion resistant type having up to about 50% by weight silicon such as CABAL 12, TA 23, FUSITE 425 or FUSITE 435. The terminal pin 28 is of molybdenum, aluminum, nickel alloy, or stainless steel, the former being preferred. The casing tube 20 is closed at its distal open end by a lower base wall or base plate 30 that is secured to the casing tube with a weld 32.

Referring now to FIG. 2, the anode 12 comprises a cylindrically-shaped layer of lithium that is in direct physical contact with the inner cylindrical surface 20E of the casing tube 20. Preferably, there is a relatively short length of the casing tube adjacent to both its proximal and distal annular rims 20B, 20C that is left uncontacted by the lithium layer 12.

FIG. 3 illustrates an exemplary embodiment of a cathode current collector 34 that is useful with the electrochemical cell 10 of the present invention. The current collector 34 is a plate-shaped member extending along a longitudinal axis B-B from a proximal land 36 connected to an intermediate rectangularly-shaped portion 38, in turn, connected to an elongate undulated portion 40. The current collector 34 has a thickness defined by a front major side 34A spaced from a back major side (not shown), both sides extending to opposed edges. The intermediate portion 38 has straight edges 38A and 38B that are parallel to each other between the front and back major sides. The land 36 is shown extending laterally outwardly beyond the left straight edge 38A, but that is an exemplary embodiment of the current collector 34. Other embodiments have the land as an upward extension of the rectangularly-shaped portion 38 without any laterally extending portions. The elongate undulating portion 40 extends distally from the rectangularly-shaped portion 38 and comprises opposed undulating edges, each edge having alternating crests 40A and troughs 40B between the front and back major sides. The current collector 34 further has a series of aligned openings 42 through its thickness. The openings 42 are centered between outwardly extending crests 40A of the opposed undulating edges. Suitable materials for the cathode current collector 34 include titanium, carbon coated titanium for use with CFₓ, tantalum, platinum, gold, aluminum, cobalt nickel alloys, highly alloyed ferritic stainless steel containing molybdenum and chromium, and nickel-, chromium- and molybdenum-containing alloys, the former being preferred.

The cathode 14 is then assembled by contacting a cathode active material, for example, fluorinated carbon CFₓ, to the undulating portion 40 of the current collector 34. The cathode active material 14 as a unitary body is supported in a surrounding and contact relationship with the undulating portion 40 so that the active material fills in and around the crests and troughs 40A, 40B of the opposed undulating edges, and in the openings 42 where the active material locks to itself. The undulating edges of crests and troughs 40A, 40B, and the openings 42 serve as irregularly-shaped surfaces that prevent the cathode active material 14 from losing contact with the current collector 34. That way, the cathode active material 14 is incapable of sliding in an axial direction along the longitudinal axis B-B of the current collector 34 as well as being prevented from separating and delaminating from the front and back major sides and the opposed undulating edges of crests and troughs 40A, 40B.

As shown in FIGS. 1A and 2, the thusly formed cathode 14 has a substantially circular cross-section along the longitudinal axis B-B of the current collector 34 and comprises a cylindrically-shaped sidewall 14A having a circumference (FIG. 2) that extends to an upper end 14B spaced from a lower end 14C. In that manner, the height of the cathode 14 extends from the upper end 14A to the lower end 14B and is designed as C_{H} in the drawing. The upper and lower ends 14A, 14B of the cathode are generally planar.

While the cathode active material comprising the cathode 14 is preferably fluorinated carbon (CFₓ), other suitable active materials include silver vanadium oxide (SVO), copper silver vanadium oxide, copper vanadium oxide, manganese dioxide, titanium disulfide, copper oxide, copper sulfide, iron sulfide, iron disulfide, lithium cobalt oxide, and mixtures thereof.

As further shown in FIGS. 1 and 1A, a polymeric insulator disc 44 is supported on the terminal pin 28, seated against an inner face of the lid 24 of the GTMS 22 and spaced upwardly from the upper end 14A of the cathode 14. In this position, the outer surrounding edge of the disc 44 meets the inner cylindrical surface 20E of the casing tube 20. The insulator disc 44 is of a fluoro-polymer, such as ethylene tetrafluoroethylene (ETFE), and helps prevent attack of the insulator glass 26 by electrolyte.

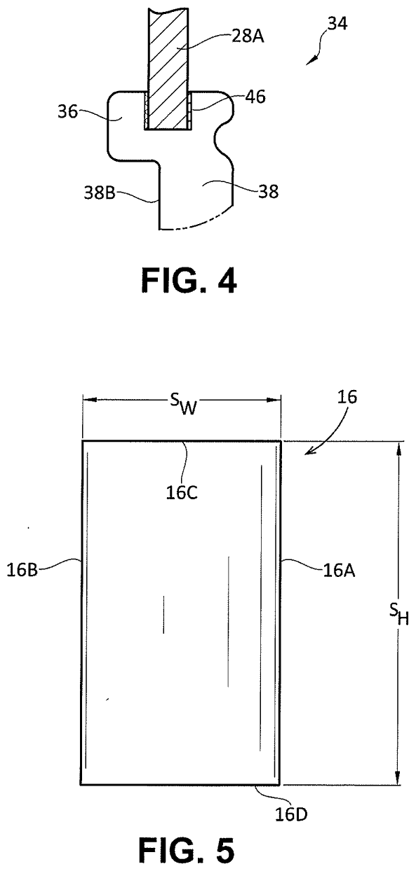

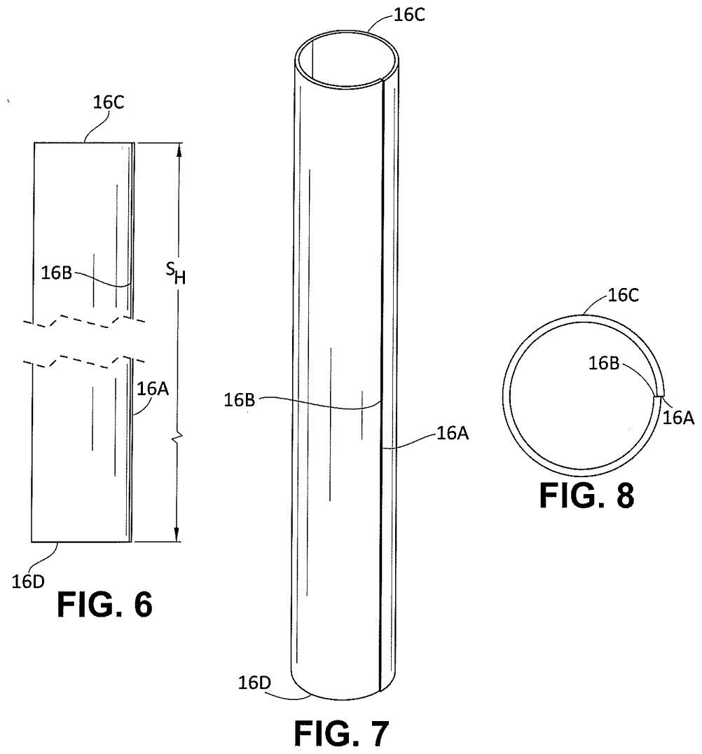

To connect the GTMS 22 to the cathode 14, the proximal end 28A of the terminal pin 28 is then connected to the land 36 of the current collector 34 by a weld 46 (FIG. 4). The connection of the terminal pin 28 to the current collector 34 at the land 36 below the insulator disc 44 remains uncontacted with cathode active material 14.

As shown in FIG. 5, the separator 16 is a generally rectangular sheet of polymeric material having a width that extends from a right lateral edge 16A to a left lateral edge 16B. The right and left lateral edges 16A, 16B extend to an upper edge 16C spaced from a lower edge 16D. The width of the separator 16 from the right lateral edge 16A to the left lateral edge 16B is designated as S, in the drawing while the height of the separator from the upper edge 16C to the lower edge 16D is designated as S_{H} in the drawing.

Illustrative separator materials include fabrics woven from fluoropolymeric fibers including polyvinylidine fluoride, polyethylenetetrafluoroethylene, and polyethylenechlorotrifluoroethylene used either alone or laminated with a fluoropolymeric microporous film, non-woven glass, polypropylene, polyethylene, glass fiber materials, ceramics, a polytetrafluoroethylene membrane commercially available under the designation ZITEX (Chemplast Inc.), a polypropylene membrane commercially available under the designation CELGARD (Celanese Plastic Company, Inc.) and a membrane commercially available under the designation DEXIGLAS (C.H. Dexter, Div., Dexter Corp.).

To wrap the cathode 14 in the separator 16 in a way that does not create a heat-sealed seam down the side of the cylindrical cathode 14, the separator sheet is first rolled around a mandrel (not shown) to form a separator tube. After the mandrel is removed, the cylindrically-shaped cathode 14 is inserted into the separator tube. Then, the upper edge 16C and upper portions of the opposed first and second lateral edges 16A, 16B of the separator tube are sealed together to cover the cathode upper end 14B, and the lower edge 16D and lower portions of the first and second lateral edges 16A, 16B of the separator tube are sealed together to cover the cathode lower end 14C, but an intermediate section of the separator first and second lateral edges 16A, 16B between the cathode upper and lower ends 14A, 14B is left unsealed.

In other words, the sealed portion of the separator 16 constituting the upper edge 16C and upper portions of the opposed first and second lateral edges 16A, 16B is spaced above the upper end 14B of the cathode 14. Similarly, the sealed portion of the separator 16 constituting the lower edge 16D and lower portions of the first and second lateral edges 16A, 16B is spaced below the lower edge 14C of the cathode 14. However, those portions of the separator right and left edges 16A and 16B that reside between the upper and lower sealed separator portions, and which are laterally aligned with the cathode between the cathode upper and lower ends 14A and 14B are closely spaced to each other but left unsealed. Since the upper and lower ends of the cathode 14 covered by the sealed separator sheet do not face anode active material 12, there is no degradation in discharge performance attributed to them.

However, the sealed separator adjacent to the opposed cathode ends 14A, 14B prevents the separator 16 from unwrapping from around the cathode 14. Thus, the partially sealed separator tube of the present invention has the advantage of a full 360° profile of opposed anode and cathode active materials 12, 14 without an intermediate ion impervious separator seam, thereby improving cell performance, particularly in miniature sized electrochemical cells.

Thus, an important aspect of the present invention is that the width S_{w} of the separator 16 is substantially equal to the circumference (FIG. 2) of the cylindrically-shaped sidewall 14A of the cathode 14. In one embodiment, the width S_{w} of the separator 16 is substantially equal to the circumference of the cathode sidewall 12A so that with the separator 16 wrapped around the cathode 14, the first and second lateral edges 16A, 16B butt up to each other, but they are unsealed. In another embodiment, the width S_{w} of the separator 16 is a little longer than the circumference of the cathode sidewall 14A so that with the separator wrapped around the cathode 14, the first and second lateral edges 14A, 14B overlap from about 0.5 mm to about 5 mm but are not sealed to each other. In other words, the width S_{w} of the separator 16 is from about 0.5 mm to about 5 mm greater than the circumferential length of the cathode sidewall 14A.

With the cathode 14 enveloped in the ionically porous polymeric separator 16 as described above, the terminal pin 28 extending outwardly from the proximal land 36 of the current collector 34 and the intermediate portion 38 of the current collector 34 protrude outwardly from the separator 16.

The height of the anode 12 along the axial length of the casing tube 20 is somewhat longer than the height of the cathode 14. The greater height of the anode 12 in comparison to the cathode 14 accommodates for some misalignment between the electrodes while maintaining anode material always opposite the cathode active material.

As previously described, the terminal pin 28 is supported in the GTMS 22 by the insulator glass 26. The lid 22 comprising the GTMS 22 is welded, such as by laser welding, to the proximal open end of the casing tube 20 to hermetically close the proximal open end of the casing tube. The terminal pin 28 connected to the current collector 34 contacting the cathode active material 14 and being electrically isolated from the lid 24 and casing 20 by the insulator glass 26 serves as the positive terminal for the electrochemical cell 10.

An electrolyte (not shown) is then filled into the casing tube 20 to activate the electrode assembly. This can be done in a number of ways including through the lower open end 20C of the casing tube prior to that end being closed by the base plate 30 secured to the tube 20 by weld 32. The electrolyte can also be filled into the casing through a separate fill port (not shown) in the lid 24. After electrolyte filling, the fill port in the lid 24 is hermetically sealed with a closure plug, as is well known by those skilled in the art.

By way of example, in an illustrative primary cell, anode comprising lithium 12 contacted to the inner surface 20E of the casing tube 20 serve as the negative terminal for the electrochemical cell 10. The preferred cathode active material is CFₓ contacted to the cathode current collectors 34. This electrochemical couple is preferably activated with an exemplary electrolyte comprising a 1.0M solution of LiBF₄ in γ-butyrolactone. A lithium/silver vanadium oxide (Li/SVO) couple is typically activated with an electrolyte comprising 1.0M to 1.4M of LiAsF₆ or LiPF₆ in a 50:50 mixture of, by volume, 1,2-dimethoxyethene and propylene carbonate.

In that respect, the electrochemical cell 10 is preferably built in a case-negative design with the casing tube 20 serving as the negative terminal. However, the cell 10 can also be built in a case-positive design with the electrode 14 shown in FIGS. 1, 1A and 2 being the anode and the other electrode 12 being the cathode. Both the case-negative and case-positive electrode designs are well known by those skilled in the art.

It is appreciated that various modifications to the inventive concepts described herein may be apparent to those skilled in the art without departing from the spirit and scope of the present invention as defined by the hereinafter appended claims.

1. An electrochemical cell, comprising:
a) a casing comprising a casing tube extending to closed upper and lower ends, wherein the casing tube has an inner annular surface;
b) a glass-to-metal seal (GTMS) comprising an insulator glass contacting a terminal pin and supported in an opening in the casing, wherein a proximal portion of the terminal pin extends into the casing and a distal portion of the terminal pin extends outwardly beyond the casing;
c) an electrode assembly housed inside the casing, the electrode assembly comprising:
i) an anode comprising an anode active material contacted to at least the inner annular surface of the casing tube;
ii) a cathode, comprising:
A) a current collector connected to the proximal portion of the terminal pin inside the casing; and
B) a cathode active material contacted to the cathode current collector inside the casing, spaced from the anode active material,
C) wherein the cathode has a sidewall extending from a cathode upper end to a spaced-apart cathode lower end; and
iii) a separator having a width extending from a first lateral edge to a spaced-apart second lateral edge with the separator first and second lateral edges extending from an upper edge to an opposite lower edge, wherein, with the separator wrapped around the cathode sidewall to segregate the anode active material from direct physical contact with the cathode active material, the separator upper edge covers the cathode upper end, and the separator lower edge covers the cathode lower end; and
d) an electrolyte in the casing activating the electrode assembly,
e) wherein the casing comprising the inner annular surface of the casing tube contacting the anode active material serves as a negative terminal, and the cathode current collector contacting the cathode active material and being connected to the proximal portion of the terminal pin electrically isolated by the GTMS from the casing serves as the positive terminal for the cell.

2. The electrochemical cell of claim 1, wherein the separator first and second lateral edges butt up to each other, but they are unsealed.

3. The electrochemical cell of claim 1, wherein the separator first and second lateral edges overlap but are not sealed to each other.

4. The electrochemical cell of claim 1, wherein the separator upper edge covers the cathode upper end and is sealed to itself, and the separator lower edge covers the cathode lower end and is sealed to itself, but the separator first and second lateral edge are not sealed to each other.

5. The electrochemical cell of claim 1, wherein the cathode sidewall has a circumferential length, and a width of the separator extending from the first to the second lateral edges thereof is substantially equal to the circumferential length of the cathode sidewall.

6. The electrochemical cell of claim 5, wherein the width of the separator is from about 0.5 mm to about 5 mm greater than the circumferential length of the cathode sidewall.

7. The electrochemical cell of claim 1, wherein the cathode sidewall is a cylindrically-shaped sidewall.

8. The electrochemical cell of claim 1, wherein the anode active material is lithium, and the cathode active material is fluorinated carbon (CFₓ).

9. The electrochemical cell of claim 1 having a total volume that is less than about 0.5 cc.

10. An electrochemical cell, comprising:
a) a casing, comprising:
i) a casing tube extending upwardly from a base wall to an upper annular edge surrounding an upper open end of the casing tube, wherein the casing tube has an inner annular surface;
ii) a lid secured to the upper annular edge to close the upper open end of the casing tube, wherein the lid has at least a first lid opening;
iii) an insulator glass contacting a terminal pin and supported in the first lid opening, wherein a proximal portion of the terminal pin extends into the casing and a distal portion of the terminal pin extends outwardly beyond the casing; and
b) an electrode assembly housed inside the casing, the electrode assembly comprising:
i) an anode comprising lithium contacted to the inner annular surface of the casing tube;
ii) a cathode, comprising:
A) a current collector connected to the proximal portion of the terminal pin inside the casing; and
B) a cathode active material contacted to the cathode current collector inside the casing, spaced from the anode active material contacted to the inner annular surface of the casing tube,
C) wherein the cathode has a sidewall extending from a cathode upper end to a spaced-apart cathode lower end; and
iii) a separator, comprising:
A) a width extending from a first lateral edge to a spaced-apart second lateral edge with the separator first and second lateral edges extending from an upper edge to an opposite lower edge,
B) wherein, with the separator wrapped around the cathode sidewall to segregate the anode active material from direct physical contact with the cathode active material, an upper portion of the separator first and second lateral edges and the separator upper edge are sealed together to cover the cathode upper end, and a lower portion of the separator first and second lateral edges and the separator lower edge are sealed together to cover the cathode lower end; and
c) an electrolyte in the casing activating the electrode assembly,
d) wherein the lid closing the casing tube contacting the anode active material serves as a negative terminal, and the cathode current collector contacting the cathode active material and being connected to the proximal portion of the terminal pin electrically isolated by the insulating glass from the lid connected to the casing tube serves as the positive terminal for the cell.

11. The electrochemical cell of claim 10, wherein an intermediate section of the separator first and second lateral edges disposed between the upper and lower portions of the separator first and second lateral edges sealed to the respective separator upper and lower edges is unsealed.

12. The electrochemical cell of claim 11, wherein the separator first and second lateral edges in the intermediate section butt up against each other.

13. The electrochemical cell of claim 11, wherein the separator first and second lateral edges in the intermediate section overlap by about 0.5 mm to about 5 mm but they are not sealed to each other.

14. The electrochemical cell of claim 10, wherein the cathode sidewall has a circumferential length, and a width of the separator extending from the first to the second lateral edges thereof is substantially equal to the circumferential length of the cathode sidewall.

15. The electrochemical cell of claim 10, wherein the lid has a second opening serving as an electrolyte fill port, and the second opening is closed after the electrolyte activates the electrode assembly.

16. A cathode assembly for an electrochemical cell, the cathode assembly comprising:
a) a cathode comprising:
i) current collector; and
ii) a cathode active material contacted to the current collector, wherein the cathode has a sidewall extending from a cathode upper end to a spaced-apart cathode lower end; and
b) a separator having a width extending from a first lateral edge to a spaced-apart second lateral edge with the separator first and second lateral edges extending from an upper edge to an opposite lower edge,
c) wherein, with the separator wrapped around the cathode sidewall, an upper portion of the separator first and second lateral edges and the separator upper edge are sealed together to cover the cathode upper end, and a lower portion of the separator first and second lateral edges and the separator lower edge are sealed together to cover the cathode lower end.

17. The cathode assembly of claim 16, wherein an intermediate section of the separator first and second lateral edges disposed between the upper and lower portions of the separator first and second lateral edges sealed to the respective separator upper and lower edges is unsealed.

18. The cathode assembly of claim 17, wherein the separator first and second lateral edges in the intermediate section butt up against each other but are unsealed.

19. The cathode assembly of claim 17, wherein the separator first and second lateral edges in the intermediate section overlap by about 0.5 mm to about 5 mm but they are not sealed to each other.

20. The cathode assembly of claim 16, wherein the cathode sidewall has a circumferential length, and a width of the separator extending from the first to the second lateral edges thereof is substantially equal to the circumferential length of the cathode sidewall.

21. (canceled)
